(19) United States
(12) Patent Application Publication
(10) Pub. No.: US 2025/0156681 A1
(43) Pub. Date: May 15, 2025

(54) SECURELY INTEGRATING STORED ACCOUNT DATA WITH EXTERNAL WORKFLOWS AND LARGE LANGUAGE MODELS

(71) Applicant: Dropbox, Inc., San Francisco, CA (US)

(72) Inventors: Timothy Palpant, New York, NY (US); Lisa Murphy, Kensington, CA (US)

(21) Appl. No.: 18/507,630

(22) Filed: Nov. 13, 2023

(51) Int. Cl. G06N 3/0455

(52) U.S. Cl. CPC G06N 3/0455

(57) ABSTRACT

The present disclosure relates to systems, non-transitory computer-readable media, and methods for using a large language model and digital content items (e.g., digital files) stored in a content management system to generate workflow outputs for external computing platforms. For instance, in some embodiments, the disclosed systems receive a workflow request that includes a natural language description of an objective to be accomplished via a workflow. The disclosed systems determine an action plan for completing the workflow and executes the action plan by accessing digital content items (e.g., digital files) stored in a content management system and extracting or generating data from the contents of the digital content items. Further, the disclosed systems use a large language model to generate a workflow output that is provided to an external computing platform for use.

### BACKGROUND

Recent years have seen significant developments in content management systems that allow for the maintenance and use of stored digital content in useful ways. For instance, some content management systems implement internal models or other features that facilitate the use of digital content stored therein within various workflows. Despite these advances, existing content management systems exhibit a number of problems in relation to efficiency and security.

Indeed, many conventional content management systems are inefficient. In particular, many conventional systems offer inefficient solutions for executing workflows that integrate stored digital content with external systems. For instance, conventional systems often require a significant number of user interactions with both the conventional content management system and a target external system to leverage stored digital content in a workflow that incorporates the external system. To illustrate, to publish stored digital content on an external system, many conventional systems require a tedious sequence of user interactions for launching the content management system, searching for the desired digital content, copying the desired digital content, exiting the content management system, launching the external system, navigating to a target location within the external system, and selecting the appropriate tools to publish the copied content. Conventional systems often require this sequence to be repeated for separate pieces of digital content, leading to user interactions that could number in the hundreds, thousands, or more.

In addition to inefficiencies, conventional content management systems often fail to securely implement workflows that integrate stored digital content with external systems or tools. Indeed, providing stored digital content directly to an external system or tool risks the exposure of sensitive information contained therein. Thus, conventional systems often fail to balance security needs with the need to use digital content in a workflow.

These along with additional problems and issues exist with regard to conventional large language model systems.

### SUMMARY

Embodiments of the present disclosure provide benefits and/or solve one or more of the foregoing or other problems in the art with systems, non-transitory computer-readable media, and methods that securely use a large language model to efficiently produce workflow outputs for external computing platforms based on natural language inputs. To illustrate, the disclosed systems can receive a natural language description of an objective involving one or more digital content items (e.g., one or more digital files) stored on a content management system and an external computing platform. The disclosed systems can use an artificial intelligence tooling platform to execute the workflow, implementing a large language model in the process. For instance, in some cases, the disclosed systems use the large language model to generate new content based on the digital content item(s) and/or instruct the artificial intelligence tooling platform in communicating with the external computing platform to complete the workflow. In some embodiments, the disclosed systems use application programming interfaces of the content management system to extract or generate content to be provided to the large language model for generation of the new content. In this manner, the disclosed systems efficiently generate workflow outputs while securely preventing access by external systems to the digital content stored in the content management system.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example environment in which an external content generation system operates in accordance with one or more embodiments.

FIG. 2 illustrates an overview diagram of the external content generation system generating digital content for an external computing platform in accordance with one or more embodiments.

FIG. 3 illustrates the external content generation system determining data from one or more digital files in accordance with one or more embodiments.

FIG. 4 illustrates the external content generation system generating a workflow output in accordance with one or more embodiments.

FIG. 5 illustrates a summary diagram of generating digital content for a workflow output based on the contents of digital files in accordance with one or more embodiments.

FIG. 6 illustrates a flowchart of a series of acts for generating a workflow output for an external computing platform based on a natural language description of an objective in accordance with one or more embodiments.

FIG. 7 illustrates a block diagram of an exemplary computing device in accordance with one or more embodiments.

FIG. 8 illustrates a network environment of a content management system in accordance with one or more embodiments.

### DETAILED DESCRIPTION

One or more embodiments described herein include an external content generation system that executes workflows by using a large language model to produce outputs for external computing platforms. In particular, in one or more embodiments, the external content generation system executes a workflow based on input having a natural language description of an objective to be achieved. The external content generation system can break down the objective into a plurality of tasks (i.e., a workflow) using an artificial intelligence tooling platform. The external content generation system can execute each task using one or more digital content items (e.g., one or more digital files) that are stored on a digital content management system and are relevant to the objective. In some cases, the external content generation system further uses a large language model for the tasks. By completing each task, the external content generation system produces a workflow output, which can include digital content and instruction for using the digital content via an external computing platform (e.g., publishing the digital content on the external computing platform).

To illustrate, in one or more embodiments, the external content generation system receives, from a client device, a workflow request comprising a natural language description of an objective to accomplish using one or more digital content items (e.g., one or more digital files) stored in a content management system. The external content generation system segments the workflow request into a set of tasks for accomplishing the objective. Further, the external content generation system determines data from the one or more digital content items stored in the content management system via execution of one or more of the tasks. Using the data determined from the one or more digital content items and a large language model, the external content generation system generates a workflow output having a computer instruction that is executable by an external computing platform.

As just mentioned, in some embodiments, the external content generation system generates workflow outputs based on workflow requests. For instance, in some cases, the external content generation system receives user input (e.g., via a client device of a user) that provides a workflow request. The workflow request can include a natural language description of an objective to be accomplished. To illustrate, the natural language description can provide an action to be taken, one or more digital content items (e.g., one or more digital files or folders) stored on a content management system to use in performing the action, and/or an external computing platform to involve as part of the workflow.

As further mentioned, based on receiving the workflow request, the external content generation system determines a set of tasks for accomplishing the objective. In other words, the external content generation system determines a workflow that, when completed, satisfies the objective provided in the natural language description.

In one or more embodiments, the external content generation system completes at least one of the tasks using one or more digital files (or other digital content items) stored on a content management system (e.g., one or more digital files identified in the workflow request). In particular, in some embodiments, the external content generation system performs the task(s) by determining data from the digital file(s). To illustrate, the external content generation system can extract data segments from the digital file(s) and/or generate derived data segments from the digital file(s). In some instances, the external content generation system communicates with one or more application programming interfaces and/or uses one or more models (e.g., machine learning models) of the content management system in determining the data from the digital file(s).

In some implementations, the external content generation system completes one or more of the tasks using a large language model. For instance, in some cases, the external content generation system uses a large language model to provide instruction for completing the task. In some instances, the external content generation system uses the large language model to generate digital content. For example, the external content generation system can use the large language model to generate digital content based on data determined from one or more files stored on the content management system.

In completing the set of tasks determined from the workflow request, the external content generation system can generate a workflow output. In some cases, the workflow output includes digital content, such as digital content generated using a large language model. In some implementations, the workflow output includes a computer instruction that is executable by an external computing platform (e.g., executable by an application programming interface of the external computing platform). Thus, the external content generation system can provide the workflow output to the external computing platform.

The external content generation system provides several advantages over conventional content management systems. For instance, the external content generation system operates more efficiently when compared to conventional systems. In particular, the external content generation system reduces the number of user interactions required to execute workflows. Indeed, by executing a workflow in response to receiving a natural language description of an objective, the external content generation system eliminates the user interactions typically required under conventional systems to complete the tasks of the workflow. Rather, upon receiving the natural language description, the external content generation system determines which tasks to complete, determines how to complete each task, and executes each task by accessing stored content, generating new content, and/or communicating with various application programming interfaces to ensure completion.

Additionally, the external content generation system provides improved security when compared to conventional systems. In particular, the external content generation system offers improved security of digital content stored on a content management system. For example, the external content generation system prevents external systems, such as external computing platforms or even external large language models, from accessing digital files (or other digital content items) stored on the content management system. Further, the external content generation system prevents the external systems from accessing the digital content stored within those digital files. For instance, by determining data (e.g., a file description or textual summary) from the one or more digital files and using a large language model to generate digital content based on that data, the external content generation system provides distillations of the file content to the large language model rather than the file content itself.

As illustrated by the foregoing discussion, the present disclosure utilizes a variety of terms to describe features and advantages of the field object generation system. Additional detail is now provided regarding the meaning of such terms. For example, as used herein, the term “workflow” refers to one or more tasks. In some instances, a workflow includes a sequence of tasks where the result of one task is used in executing a next task (e.g., the next task is reliant on execution of the preceding task). In some cases, one or more of the tasks can be or are completed in parallel. In other words, in some instances, one or more of the tasks do not rely on the result of a preceding task.

Additionally, as used herein, the term “workflow request” refers to a request or instruction to execute a workflow. In particular, a workflow request can refer to a request or instruction to produce one or more outcomes via a workflow. A workflow request can indicate, among other things, one or more outcomes to result from the workflow, one or more tasks to perform in executing the workflow, one or more sources of data to use in executing the workflow, one or more models to use in executing one or more of the tasks, and/or one or more computing platforms to involve in the workflow.

Further, as used herein, the term “workflow output” refers to an output of a workflow. In particular, a workflow output can refer to an output of a workflow produced by the external content generation system or produced in response to a request or instruction of the external content generation system upon completion of a workflow. For instance, in some cases, a workflow output includes digital content generated by the external content generation system via completion of the workflow. In some embodiments, a workflow output includes a computer instruction that is generated by the external content generation system and provided to an external computing platform for execution upon completion of the workflow.

As used herein, the term “objective” refers to a goal or purpose of a workflow. In particular, an objective can refer to one or more results to be produced or otherwise provided upon completion or execution of a workflow. Examples of an objective include, but are not limited to, the access of digital content or a digital file, the generation of new digital content or a new digital file, a submission to or post on an external computing platform, a communication to an external computing platform, or the provision of a digital content or a digital file or a link to the digital content or digital file.

As used herein, the term “data” refers generally to information. For instance, data can include information with respect to some subject or topic. In some cases, data can include information with respect to multiple subjects and/or topics even if they are unrelated. Indeed, in some instances, data generally refers to a collection of information.

Relatedly, as used herein, the term “data segment” refers to a particular piece of information or set of data. For instance, in some cases, a data segment includes a piece of information or set of data related to a particular subject or topic. Indeed, while data more generally refers to information and may include a collection of information with respect to various subjects and/or topics, a data segment can include a piece of information or set of data that corresponds to a single subject or topic. As used herein, the term “extracted data segment” includes a data segment that has been extracted from a source. For instances, in some cases, an extracted data segment includes the data from the source as it was when part of the source. As used herein, the term “derived data segment” includes a data segment that was generated based on a source. For instance, a derived data segment can include a data segment that was generated based on a portion of a source or based on the source in its entirety.

As used herein, the term “digital file” refers to a computer-based collection of data formatted in a single digital representation. In particular, a digital file can include a collection of data that is cohesively represented as a block or unit that is available to a computer platform or program for reading, processing, and/or manipulation. A digital file can include contents, have metadata (e.g., metadata corresponding to the contents or the digital file itself), and/or be represented in one of various formats. Examples of a digital file include, but are not limited to, an image file, a text file, an audio file, a video file, or a multi-media file.

As used herein, the term “digital content item” more generally refers to a collection of data or a portion of the data represented within the collection. For instance, a digital content item can include a digital file or a portion of a digital file. Examples of portions of a digital file include, but are not limited to, an audio segment of an audio file (e.g., a song on a playlist), a digital image of an image file (e.g., a single image from a collection of images), a section within a text file (e.g., an article within a text file comprising a collection of articles).

Additionally, as used herein, the term “digital content” refers to data represented in a digital format. Digital content can include the data (e.g., contents) included in or associated with a digital file or contents unassociated with a digital file. In some instances, digital content includes digitally represented data that has been generated from other data, such as other digital content. Relatedly, the term “content” more generally refers to data represented in a digital format or another format. Thus, content can include digital content and the two terms may be used interchangeably. As used herein, the term “viewable content” refers to digital content that can be viewed. In particular, viewable content can include digital content that is viewable with the use of a computing device. For instance, viewable content can include digital content that is displayable on a user interface (e.g., a graphical user interface) of a computing device.

Further as used herein, the term “listing content” refers to digital content to be used for a listing. In particular, listing content can include digital content that can be incorporated within or at least used in creating a listing-such as a listing that is generated by, published on, and/or maintained by a listing platform. In some cases, listing content provides detail (e.g., text, image, or audio detail) for one or more items or services. As one example, listing content can include digital content that can be incorporated within or at least used in creating an ecommerce listing on an ecommerce platform. As used herein, the term “ecommerce listing” refers to a listing for a product or service that is generated by, published on, and/or maintained by an ecommerce platform. For instance, an ecommerce listing can include a web page of an ecommerce platform that describes a product or service and allows a customer to initiate a transaction with respect to the product or service, such as a transaction for purchasing or renting the product or service. In some cases, an ecommerce listing can include an advertisement published on another platform (e.g., a social networking platform) that advertises a product or service that can be transacted for on an ecommerce platform.

As used herein, the term “machine learning model” refers to a computer algorithm or a collection of computer algorithms that automatically improve for a particular task through iterative outputs or predictions based on the use of data. For example, a machine learning model can utilize one or more learning techniques to improve accuracy and/or effectiveness. Example machine learning models include various types of neural networks, decision trees, support vector machines, linear regression models, and Bayesian networks.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content items or field objects) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer that each perform tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a large language model.

As used herein, the term “large language model” refers to one or more machine learning models trained to perform computer tasks to generate or identify content items in response to trigger events (e.g., user interactions, such as text queries and button selections). In particular, a large language model can include a neural network (e.g., a deep neural network) with many parameters trained on large quantities of data (e.g., unlabeled text) using a particular learning technique (e.g., self-supervised learning). For example, a large language model can include parameters trained to generate model outputs (e.g., content items, summaries, or query responses) and/or to identify content items based on various contextual data, including graph information from a knowledge graph and/or historical user account behavior. In some cases, a large language model comprises a generative pre-trained transformer (GPT) model such as, but not limited to, ChatGPT.

Additionally, as used herein, the term “image description model” refers to a machine learning model for generating a description of a digital image. In particular, an image description model can include a machine learning model that analyzes a digital image and generates a description of the digital image based on its analysis. For example, an image description model can generate a textual or audio description of a digital image.

Further, as used herein, the term “text summarization model” refers to a model for, such as a machine learning model, for generating a text summary of a digital file. In particular, a text summarization model can include a machine learning model that analyzes a digital file and generates a text summary of the digital file based on its analysis. For example, a text summarization model can generate a text summary of the contents of the digital file, such as by summarizing the text contents of the digital file.

As used herein, the term “content management system” includes a computer-implemented system for managing digital content. In particular, a content management system can include a computer-implemented system for managing one or more digital files. In some cases, a content management system is particular to a computing device and manages the digital files of the computing device. In some instances, however, a content management system is accessible to and/or can be used by a plurality of computing devices. For instance, a content management system can include a remote platform that is hosted by one or more server devices and is accessible by various client devices over a network. In some cases, a content management system manages digital files for a plurality of users and allows a user to access, generate, and/or manage digital files associated with a particular user account.

Additionally, as used herein, the term “external computing platform” includes a computer platform that is external to another computing platform. For instance, an external computing platform can include a computing platform that is external to a content management system. Examples of an external computing platform include, but are not limited to, an ecommerce platform, a text document generation platform, a digital image generation platform, an audio generation platform, a spread-sheet generation platform, a multi-media (e.g., slide) generation platform, a social networking platform.

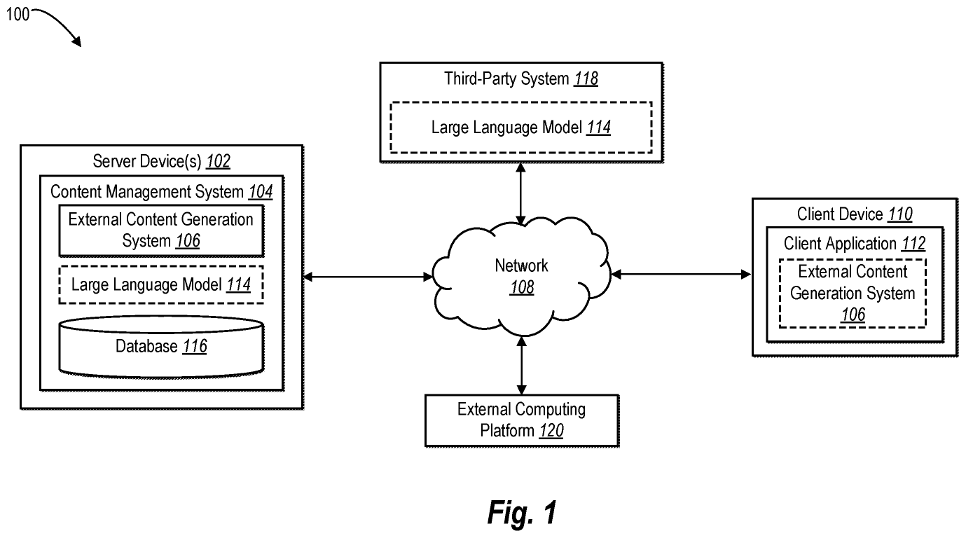

Additional details regarding the external content generation system will now be provided with reference to the figures. For example, FIG. 1 illustrates a schematic diagram of an exemplary system environment (“environment”) 100 in which an external content generation system 106 operates. As illustrated in FIG. 1, the environment 100 includes a server device(s) 102, a network 108, a client device 110, a third-party system 118, and an external computing platform 120.

Although the environment 100 of FIG. 1 is depicted as having a particular number of components, the environment 100 is capable of having any number of additional or alternative components (e.g., any number of server devices, client devices, third-party systems, external computing platforms, or other components in communication with the external content generation system 106 via the network 108). Similarly, although FIG. 1 illustrates a particular arrangement of the server device(s) 102, the network 108, the client device 110, the third-party system 118, and the external computing platform 120, various additional arrangements are possible.

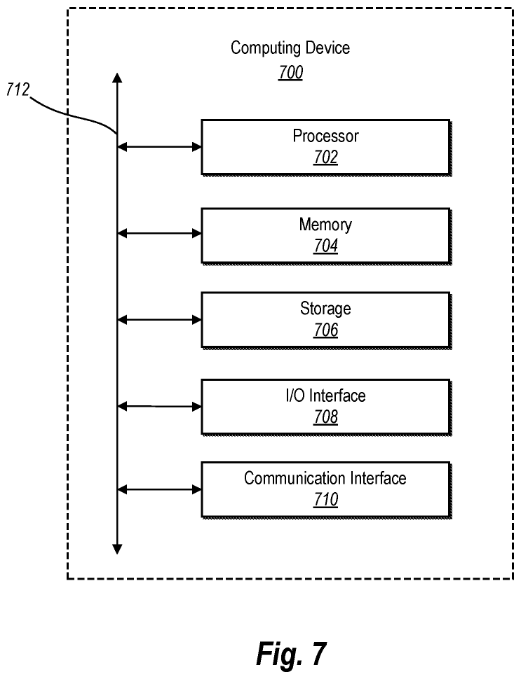

The server device(s) 102, the network 108, the client device 110, the third-party system 118, and the external computing platform 120 are communicatively coupled with each other either directly or indirectly (e.g., through the network 108 discussed in greater detail below in relation to FIG. 7). Moreover, the server device(s) 102, the client device 110, the third-party system 118, and the external computing platform 120 each include one of a variety of computing devices (including one or more computing devices as discussed in greater detail with relation to FIG. 7).

As mentioned above, the environment 100 includes the server device(s) 102. In one or more embodiments, the server device(s) 102 generates, stores, receives, and/or transmits data including digital files (or other digital content items) and/or digital content created using digital files. In one or more embodiments, the server device(s) 102 comprises a data server. In some implementations, the server device(s) 102 comprises a communication server or a web-hosting server.

In one or more embodiments, the content management system 104 provides functionality by which the client device 110 (e.g., a user of the client device 110) generates, edits, manages, and/or stores digital content, such as digital content included in digital files (or other digital content items). For example, in some instances, the client device 110 sends a digital file to the content management system 104 hosted on the server device(s) 102 via the network 108. The content management system 104 then provides many options that the client device 110 may use to edit the digital file, store the digital file, and subsequently search for, access, and view the digital file. For instance, in some cases, the content management system 104 provides one or more options that the client device 110 may use to incorporate the digital file as part of a workflow.

Additionally, the server device(s) 102 includes the external content generation system 106. In one or more embodiments, via the server device(s) 102, the external content generation system 106 generates workflow outputs for external computing platforms (e.g., the external computing platform 120). For instance, in some cases, the external content generation system 106, via the server device(s) 102, accesses one or more digital files (or other digital content items) stored in the content management system 104 (e.g., within a database 116). Additionally, the external content generation system 106 executes a workflow using the one or more digital files, which can include using a large language model 114 to generate digital content based on the one or more digital files. Via the server device(s) 102, the external content generation system 106 transmits the workflow output to the external computing platform. For instance, the external content generation system 106 can transmit digital content generated via the workflow and a computer instruction for using the digital content to the external computing device.

In one or more embodiments, the client device 110 includes a computing device that can access, edit, implement, modify, store, and/or provide, for display, digital content. For example, the client device 110 can include a smartphone, tablet, desktop computer, laptop computer, head-mounted-display device, or other electronic device. The client device 110 can include one or more applications (e.g., the client application 112) that can access, edit, implement, modify, store, and/or provide, for display, digital content. For example, in some embodiments, the client application 112 includes a software application installed on the client device 110. In other cases, however, the client application 112 includes a web browser or other application that accesses a software application hosted on the server device(s) 102.

The external content generation system 106 can be implemented in whole, or in part, by the individual elements of the environment 100. Indeed, as shown in FIG. 1 the external content generation system 106 can be implemented with regard to the server device(s) 102 and/or at the client device 110. In particular embodiments, the external content generation system 106 on the client device 110 comprises a web application, a native application installed on the client device 110 (e.g., a mobile application, a desktop application, a plug-in application, etc.), or a cloud-based application where part of the functionality is performed by the server device(s) 102.

In additional or alternative embodiments, the external content generation system 106 on the client device 110 represents and/or provides the same or similar functionality as described herein in connection with the external content generation system 106 on the server device(s) 102. In some implementations, the external content generation system 106 on the server device(s) 102 supports the external content generation system 106 on the client device 110.

In some embodiments, the external content generation system 106 includes a web hosting application that allows the client device 110 to interact with content and services hosted on the server device(s) 102. To illustrate, in one or more implementations, the client device 110 accesses a web page or computing application supported by the server device(s) 102. The client device 110 provides input to the server device(s) 102, such as a workflow request having a natural language description of an objective. In response, the external content generation system 106 on the server device(s) 102 utilizes the provided input to generate a workflow output in accordance with the objective. The server device(s) 102 then provides the workflow output (or an indication of completion of the workflow) to the client device 110.

Additionally, though FIG. 1 illustrates the database 116 as part of the content management system 104, the database 116 can be an external component in some implementations. For instance, in some embodiments, the database 116 includes a remote database (e.g., stored on a remote server) that is managed by the content management system 104 via the server device(s) 102. Further, while FIG. 1 illustrates the large language model 114 as part of the content management system 104, the large language model 114 can be part of the third-party system 118 in some implementations. Indeed, in some cases, the large language model 114 is external to the content management system but is accessible to and usable by the external content generation system 106 in generating workflow outputs for external computing platforms.

In some embodiments, though not illustrated in FIG. 1, the environment 100 has a different arrangement of components and/or has a different number or set of components altogether. For example, in certain embodiments, the client device 110 communicates directly with the server device(s) 102 bypassing the network 108. As another example, the environment 100 includes a third-party server comprising a content server and/or a data collection server.

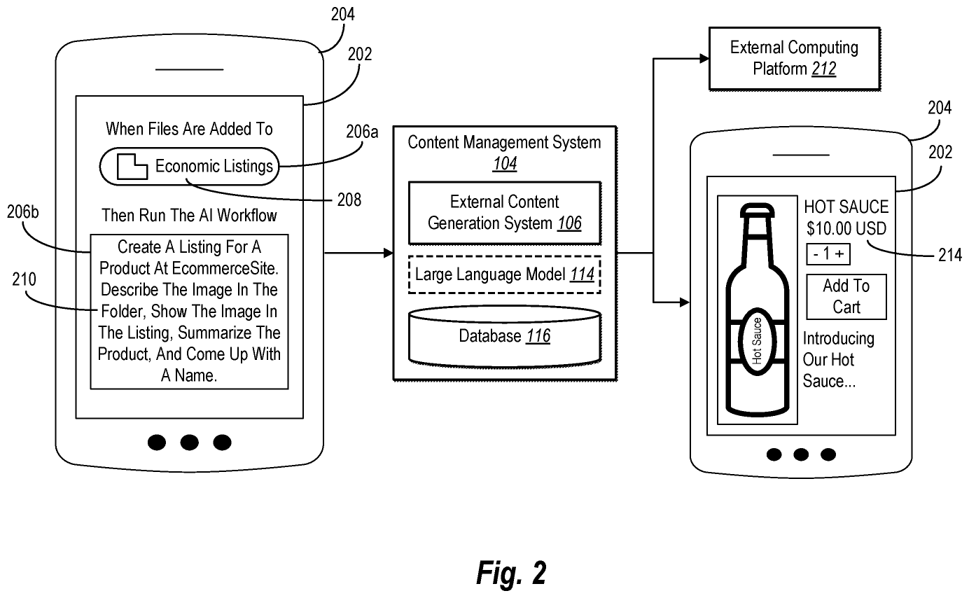

As previously mentioned, in one or more embodiments, the external content generation system 106 implements workflows and generates workflow outputs for external computing devices. FIG. 2 illustrates the external content generation system 106 executing a workflow to generate a workflow output for an external computing device in accordance with one or more embodiments.

As shown in FIG. 2, the external content generation system 106 provides a graphical user interface 202 for display on a client device 204. In particular, the external content generation system 106 provides the graphical user interface 202 to facilitate submission of a workflow request. For instance, as illustrated, the external content generation system 106 provides a first interactive option 206a (e.g., a dropdown menu) for selecting a source of digital content to use in execution of the requested workflow. Further, the external content generation system 106 provides a second interactive option 206b (e.g., a text box) for entering a natural language description of an objective to be accomplished via the requested workflow.

Thus, as illustrated by FIG. 2, the external content generation system 106 receives a workflow request via one or more user interactions with the graphical user interface 202. For instance, FIG. 2 illustrates that the workflow request includes, based on user input entered via the first interactive option 206a, an indication 208 of a folder of the content management system 104 to use in executing the workflow. In particular, the indication 208 indicates that one or more digital files that are added to the designated folder are to be used in the requested workflow. In some cases, the indication 208 directly indicates (e.g., names) the one or more digital files to be used. Though FIG. 2 and much of the description below discusses use of digital files, it should be understood that the external content generation system 106 can more generally operate using digital content items in various embodiments. For instance, in some implementations, the indication 208 indicates one or more digital content items to use in executing the workflow (or a folder of the content management system 104 in which the digital content items are located).

As further illustrated, the workflow request includes, based on user input entered via the second interactive option 206b, a natural language description 210 for executing the workflow. As shown by FIG. 2, the natural language description 210 includes natural language text describing an objective to be accomplished (e.g., the creation of a listing on an ecommerce platform) via the requested workflow. The natural language description 210 also provides detail regarding how the objective should be accomplished. In other words, the natural language description 210 provides, in natural language, a general description of steps to be taken in accomplishing the objective (e.g., describe the image in the designated folder, include the image in the listing, summarize the product, and create a name for the product/listing).

Though FIG. 2 illustrates a particular approach used to facilitate submission of a workflow request, the external content generation system 106 uses other approaches in various embodiments. For instance, while FIG. 2 suggests that the first interactive option 206a includes a dropdown menu or other interactive element for selecting a folder or digital file(s), the external content generation system 106 uses a text box for the first interactive option 206a in some cases. In some implementations, the external content generation system 106 omits the first interactive option 206a and allows the user to enter the folder (or digital file) name(s) via the second interactive option 206b (e.g., as part of the natural language description 210). Additionally, in some embodiments, the external content generation system 106 receives the natural language description 210 via voice input. Further, while FIG. 2 may suggest that the external content generation system 106 operates off a natural language description with a particular level of detail, the external content generation system 106 can execute workflows based on natural language descriptions having various levels of detail in various embodiments. To illustrate, in some implementations, the natural language description 210 describes the objective to be accomplished but omits further detail, and the external content generation system 106 executes a workflow involving pre-designated steps or based on the contents of the designated folder or digital files.

As further shown in FIG. 2, the external content generation system 106 (e.g., operating as part of the content management system 104) processes the workflow request. As indicated, the external content generation system 106 uses the large language model 114 and the database 116 in processing the workflow request. For instance, as will be described in more detail below, in some embodiments, the external content generation system 106 uses the large language model 114 in determining how to complete the tasks of the workflow and/or for generating digital content as part of the workflow. Additionally, as will be explained below, in some cases, the external content generation system 106 accesses one or more digital files stored within the database 116 and uses the contents of the digital file(s) in executing the workflow.

As illustrated in FIG. 2, the external content generation system 106 communicates with an external computing platform 212. In particular, in some embodiments, the external content generation system 106 communicates with the external computing platform 212 as part of the workflow. For instance, in some cases, the external content generation system 106 generates a workflow output and provides the workflow output to the external computing platform 212. In some instances, the workflow output includes a computer instruction that is executable by the external computing platform 212. In some implementations, the workflow output further includes digital content to be used by the external computing platform 212 via execution of the computer instruction.

Additionally, as shown in FIG. 2, the external content generation system 106 further communicates with the client device 204 upon completion of the workflow. Indeed, FIG. 2 illustrates the graphical user interface 202 of the client device 204 displaying the digital content 214 generated as part of the workflow. In particular, FIG. 2 shows the graphical user interface 202 displaying an ecommerce listing that uses the digital content 214 as listing content.

In one or more embodiments, the external content generation system 106 communicates with the client device 204 by directly providing the digital content 214 for display within the graphical user interface 202. In some cases, the external content generation system 106 provides a link that enables the client device 204 to access the digital content 214.

To illustrate, in one or more embodiments, the digital content 214 (e.g., the ecommerce listing using the digital content 214 as the listing content) is hosted on the external computing platform 212. For example, the external computing platform 212 can include an ecommerce platform that creates and/or manages ecommerce listings having listing content related to products or services. Thus, the external content generation system 106 can provide a link to the client device 204 that, when selected, enables the client device 204 to access the digital content 214 (e.g., access the ecommerce listing) on the external computing platform 212 and display the digital content 214 within the graphical user interface 202. In some instances, the external content generation system 106 provides the digital content 214 directly to the client device 204 for display within the graphical user interface 202 as a preview of the ecommerce listing hosted on the external computing platform 212.

Thus, the external content generation system 106 can execute a workflow and generate a workflow output based on a workflow request describing the desired result in natural language. In particular, the external content generation system 106 can generate a workflow output for an external computing platform using one or more digital files stored in a content management system based on the natural language description. By operating as such, the external content generation system 106 performs more efficiently when compared to conventional systems. Indeed, the external content generation system 106 reduces the user interactions typically required by conventional systems to incorporate the contents of digital files in a content management system within an external computing platform.

Though FIG. 2 provides a particular example in which the external content generation system 106 executes a workflow to generate digital content for use as listing content within an ecommerce listing hosted on an ecommerce platform, the external content generation system 106 can provide various workflow outputs in various embodiments. For instance, in some cases, the external content generation system 106 executes a workflow to generate digital content for use as a social media post on a social media platform. In some cases, the external content generation system 106 executes a workflow to generate a digital image from the contents of one or more digital files. In some embodiments, the external content generation system 106 executes a workflow to generate digital content to be incorporated within a slide deck, a work document, a spreadsheet, or another form of document created by the external computing platform.

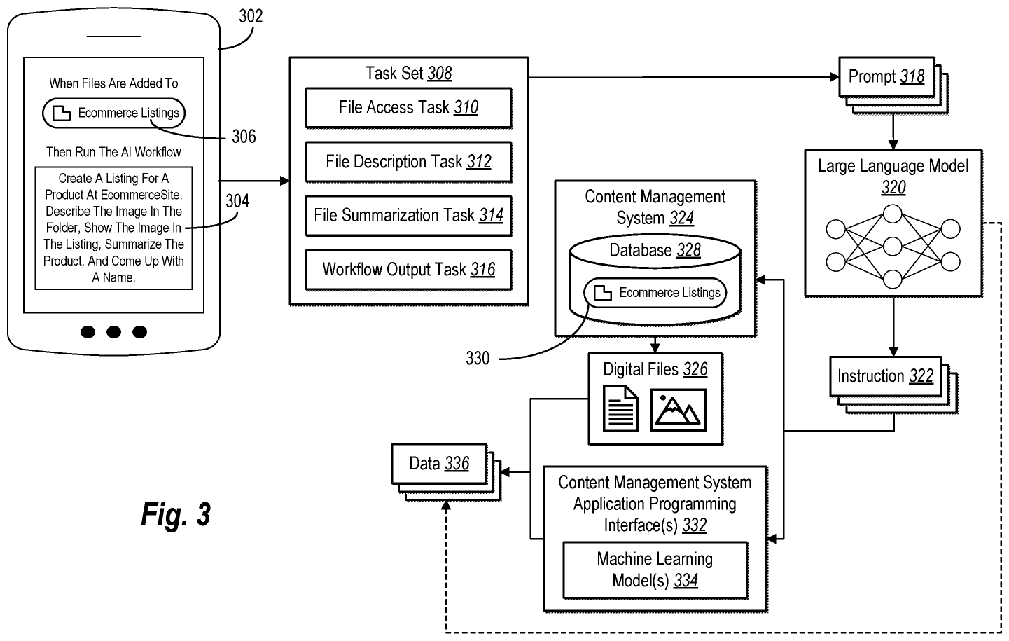

As previously mentioned, in one or more embodiments, the external content generation system 106 determines data from one or more digital files stored in a content management system. FIG. 3 illustrates the external content generation system 106 determining data from one or more digital files in accordance with one or more embodiments.

As shown in FIG. 3, the receives a workflow request via a client device 302. In particular, the external content generation system 106 receives a workflow request having a natural language description 304 and an indication 306 of a folder of a content management system 324 to use in executing the workflow.

As further shown in FIG. 3, based on the workflow request, the external content generation system 106 determines a task set 308 for executing the workflow. The task set 308 can include one or more tasks to be completed as part of the workflow. In particular, the task set 308 can include one or more tasks for accomplishing the objective described by the workflow request. FIG. 3 illustrates that the task set 308 includes a file access task 310, a file description task 312, a file summarization task 314, and a workflow output task 316. It should be understood, however, that the external content generation system 106 can determine tasks sets including additional, fewer, and/or alternative tasks in some implementations.

In one or more embodiments, the external content generation system 106 implements an artificial intelligence tooling platform for determining the task set 308 based on the workflow request. For instance, in some embodiments, the external content generation system 106 implements an artificial intelligence agent—such as Langchain, Auto-GPT, AgentGPT, or LlamaIndex—in determining the task set 308.

In one or more embodiments, the file access task 310 includes a task for accessing, locating, or identifying one or more digital files for use in the workflow. For example, as previously indicated, the workflow request can designate a folder of the content management system 324 having digital files to use in the workflow (or designate the digital files themselves). Accordingly, in some cases, the file access task 310 includes a task for locating and accessing those digital files. In some cases, the external content generation system 106 identifies and retrieves the digital files (e.g., obtains a copy of the digital files), determines a location of the digital files within the content management system 324, or accesses the contents of the digital files while the content management system 324 still maintains control over the digital files themselves.

In some embodiments, the file description task 312 includes a task for describing the contents of a digital file. In particular, the file description task 312 can include a task for describing the contents without using the contents themselves. For instance, in some cases, the file description task 312 can include a task for describing, via text, a digital image of an image file.

In some cases, the file summarization task 314 includes a task for summarizing the contents of a digital file. In particular, the file summarization task 314 can include a task for summarizing the contents by quoting, paraphrasing, highlighting, and/or condensing the contents of the digital file into a summary, such as a text summary that is shorter than the contents of the digital file. For example, in some instances, the file summarization task 314 can include a task for summarizing the text contents of a text document or other document containing text.

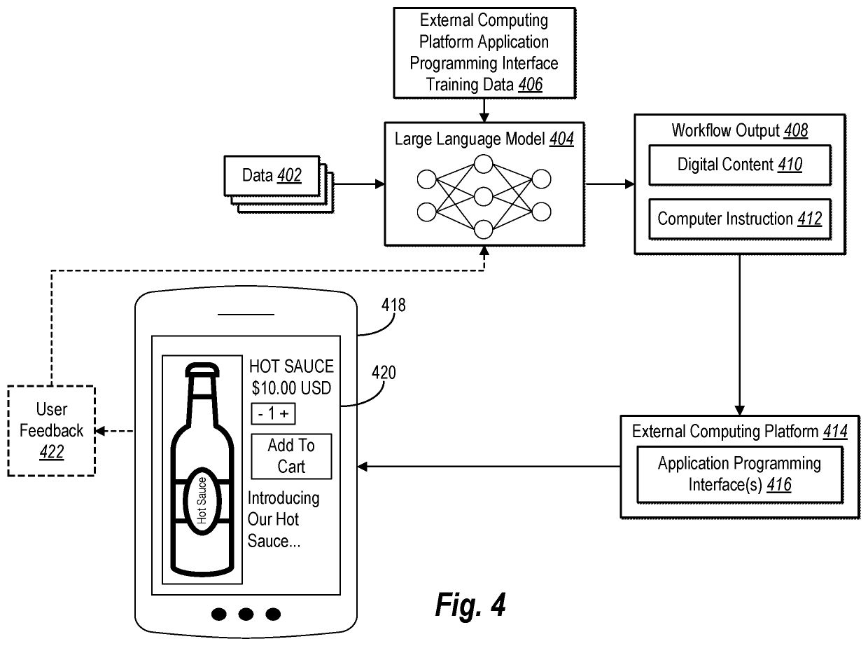

In some implementations, the workflow output task 316 includes a task for generating a workflow output. For instance, the workflow output task 316 can include a task for generating new digital content as part of the workflow output, such as by generating new digital content based on content taken or generated from the contents of accessed digital files. The workflow output task 316 can further include generating a computer instruction that is executable by an external computing platform for using the digital content. The workflow output task 316 will described in more detail with reference to FIG. 4.

As mentioned, the tasks shown in FIG. 3 are non-limiting examples of tasks that could be determined and implemented by the external content generation system 106. Other examples of tasks include, but are not limited to, tasks for extracting one or more specific portions of a digital file (e.g., extracting one or more sections, sentences, and/or keywords) or a task for generating visual content based on the contents of a digital file (e.g., generating a chart or graph based on a corresponding textual description in the digital file).

As further shown in FIG. 3, the external content generation system 106 provides prompts (e.g., the prompt 318) to a large language model 320 based on the task set 308. For example, in some cases, the external content generation system 106 provides a separate prompt for each task in the task set 308. In one or more embodiments, each prompt includes a request for instruction on completing the corresponding task. For instance, the prompt can indicate the corresponding task and provide some detail regarding the workflow request (e.g., the objective to accomplish and/or the digital file(s) to use in the workflow).

In one or more embodiments, the external content generation system 106 provides the prompts in a sequence, or at least partially in a sequence. Indeed, in some cases, at least one of the tasks depends on the results of one or more other tasks. For instance, the workflow output task 316 can rely on the outputs of the file description task 312 and/or the file summarization task 314; accordingly, the external content generation system 106 can provide the prompt for the workflow output task 316 after the file description task 312 and/or the file summarization task 314 have been completed. Further, for a task that relies on the results of one or more other tasks, the external content generation system 106 can provide the results of those other tasks as part of the prompt. In some cases, however, the external content generation system 106 provides the prompts together, in parallel, or without regard to order.

As further shown in FIG. 3, the external content generation system 106 uses the large language model 320 to generate instructions (e.g., the instruction 322) based on the prompts. For instance, the external content generation system 106 can use the large language model 320 to generate an instruction for each provided prompt. In one or more embodiments, each of the instructions provides detail on completing the corresponding task. For instance, an instruction can detail how to communicate/work with the content management system 324 or an external computing platform in completing the corresponding task. For instance, in some cases, an instruction indicates an application programming interface of the content management system 324 or the external computing platform to communicate/work to complete the corresponding task.

As illustrated by FIG. 3, the external content generation system 106 accesses one or more digital files 326 stored in the content management system 324. In particular, the external content generation system 106 accesses the one or more digital files 326 from a database 328 of the content management system 324 that stores the folder 330 that contains the one or more digital files 326 and is indicated within the workflow request (e.g., the folder 330 corresponding to the indication 306 included as part of the workflow request).

In one or more embodiments, the external content generation system 106 accesses the one or more digital files 326 as part of the file access task 310. For instance, in some cases, the external content generation system 106 utilizes the large language model 320 to generate, based on a prompt for the file access task 310, an instruction for accessing the one or more digital files 326. In some cases, the instruction indicates a location of the one or more digital files 326 (or a location of the folder 330) within the database 328. In some instances, the instruction identifies an application program interface of the content management system 324 to use in accessing the one or more digital files 326.

Indeed, as shown in FIG. 3, the external content generation system 106 also interacts with one or more application programming interfaces 332 of the content management system 324. Additionally, the external content generation system 106 can use one or more machine learning models 334 implemented by the one or more application programming interfaces 332, though a machine learning model may not be used for every task (e.g., an application programming interface for accessing digital files may not implement a machine learning model). For instance, the external content generation system 106 can use the one or more application programming interfaces 332 (including the one or more machine learning models 334) to extract data segments from the content of the one or more digital files 326 and/or to generate derived data segments from the content of the one or more digital files 326.

To illustrate, for the file description task 312, the corresponding instruction can identify an application programming interface of the content management system 324 to use in analyzing an accessed image file and generating a text description of the image file based on the analysis. In some cases, the application programming interface implements an image description model to perform the analysis and text description generation. Accordingly, in response to the instruction, the external content generation system 106 can use the identified application programming interface to implement the image description model and generate the text description for the image file. For instance, the external content generation system 106 can send a request to the identified application programming interface with the image file (or a location of the image file within the database 328) and use the application programming interface to process the request and generate the text description of the image file via the image description model.

As another illustration, for the file summarization task 314, the corresponding instruction can identify an application programming interface of the content management system 324 to use in analyzing an accessed text file and generating a text summary of the text file based on the analysis. In some cases, the application programming interface implements a text summarization model to perform the analysis and text summary generation. Accordingly, in response to the instruction, the external content generation system 106 can use the identified application programming interface to implement the text summary model and generate the text summary for the text file. For instance, the external content generation system 106 can send a request to the identified application programming interface with the text file (or a location of the text file within the database 328) and use the application programming interface to process the request and generate the text summary of the text file via the text summarization model.

In one or more embodiments, the external content generation system 106 trains the large language model 320 on the application programming interfaces of the content management system 324 prior to receiving the workflow request. In particular, the external content generation system 106 trains the large language model 320 on the functions and protocols of the application programming interfaces. Indeed, in some cases, the large language model 320 is pre-trained on a large corpus of training data, and the external content generation system 106 updates the model parameters so the large language model 320 can identify which application programming interface is appropriate for a given task and provide instruction on how to use that application programming interface in response to a prompt for the given task.

Thus, the external content generation system 106 uses one or more of the instructions generated via the large language model 320 to determine data 336 from the one or more digital files 326 stored in the content management system 324. In particular, the external content generation system 106 can access the one or more digital files 326 based on one instruction, such as the instruction that corresponds to the file access task 310. The external content generation system 106 can further determine the data 336 by analyzing the one or more digital files 326 based on one or more other instructions, such as the instructions corresponding to the file description task 312 and the file summarization task 314. In some instances, the external content generation system 106 uses the one or more application programming interfaces 332 and the one or more machine learning models 334 in determining the data 336.

As indicated by FIG. 3, in some embodiments, the external content generation system 106 uses the large language model 320 to generate the data 336 or at least a portion of the data 336 based on the tasks to be completed. For instance, in some cases, a task can be completed based on the detail provided in the natural language description 304. In particular, the external content generation system 106 can use the large language model 320 to generate at least a portion of the data 336 based on detail provided in the natural language description 304.

As further mentioned above, the external content generation system 106 generates a workflow output in response to a workflow request. In particular, the external content generation system 106 generates a workflow output using data determined from one or more digital files stored in a content management system. FIG. 4 illustrates the external content generation system 106 generating a workflow output in accordance with one or more embodiments. Indeed, FIG. 4 illustrates one or more embodiments of completing a workflow output task determined to be part of a set of tasks to accomplish an objective described in a workflow request.

Indeed, as shown in FIG. 4, the external content generation system 106 provides data 402 to a large language model 404. The data 402 can include the data determined from one or more digital files stored in a content management system as discussed in FIG. 3. Also, the large language model 404 can include the large language model used to generate the instructions for accessing the digital file(s) and determining the data from the digital file(s).

As further shown in FIG. 4, the external content generation system 106 uses the large language model 404 to generate a workflow output 408 from the data 402. In particular, the external content generation system 106 uses the large language model 404 to generate the workflow output 408 for the external computing platform 414 (e.g., the external computing platform indicated by the workflow request).

As indicated, the external content generation system 106 trains the large language model 404 to generate workflow outputs that are compatible with the external computing platform 414. In particular, as shown in FIG. 4, the external content generation system 106 uses training data 406 for one or more application programming interfaces 416 of the external computing platform 414 to train (or update) the large language model 404. Indeed, as mentioned above with reference to FIG. 3, the external content generation system 106 updates model parameters to facilitate use of one or more application programming interfaces of the content management system that stores the digital files used in the workflow. FIG. 4 illustrates that the external content generation system 106 can further update the model parameters to facilitate use of the external computing platform 414. In particular, the external content generation system 106 updates the model parameters based on the functions and protocols of the one or more application programming interfaces 416 of the external computing platform 414. As such, the external content generation system 106 ensures that the workflow output 408 generated by the large language model 404 is compatible with (e.g., implements) those functions and protocols.

As shown in FIG. 4, the workflow output 408 includes digital content 410. In one or more embodiments, the external content generation system 106 uses the large language model 404 to generate the digital content 410 by generating new digital content based on the data 402. In particular, the external content generation system 106 uses the large language model 404 to generate digital content that can be used by the external computing platform 414. For instance, the digital content 410 can include content that is formatted in accordance with the protocols of the external computing platform 414. Further, the digital content 410 can include content that is relevant to the external computing platform 414.

To illustrate, where the external computing platform 414 includes an ecommerce platform, the digital content 410 can include content that can be used as listing content for an ecommerce listing. For instance, the external content generation system 106 can generate the digital content 410 to include content that provides detail that enhances the attractiveness of the product or service that is being listed on the ecommerce platform. In other words, while the data 402 may include straightforward, factual details that strictly describe the contents of the accessed digital files, the digital content 410 can include a more imaginative description that incorporates more ornate or figurative language that has been learned by the large language model 404 to be more pleasing to prospective customers. Further, while the data 402 may include various disjointed data segments (e.g., extracted data segments and/or derived data segments), the digital content 410 can include a more cohesive description of the product or service that is being listed.

As just indicated, in some cases, the digital content 410 includes new digital content that is generated by extracted data segments and/or derived data segments represented in the data 402. In some instances, the digital content 410 further includes the content of at least one digital file accessed via one of the tasks determined from the workflow request (e.g., a file access task). To illustrate, in response to a workflow request for creating an ecommerce listing on an ecommerce platform, the external content generation system 106 can include a digital image from an image file in the digital content 410. Accordingly, in some instances, the external content generation system 106 combines the digital image with the digital content created by the large language model 404 to create the digital content 410 of the workflow output 408.

As further shown in FIG. 4, the workflow output 408 also includes a computer instruction 412. In particular, the computer instruction 412 can include a computer instruction that is executable by the external computing platform 414 (e.g., by the one or more application programming interfaces 416 of the external computing platform 414). For instance, the computer instruction 412 can include an instruction to the external computing platform 414 for using the digital content 410 in accordance with the objective of the workflow request. In particular, the computer instruction 412 can include an instruction that is formatted according to the protocols of the one or more application programming interfaces 416.

To illustrate, where the external computing platform 414 includes an ecommerce platform, the computer instruction 412 can include an instruction to use the digital content 410 in creating an ecommerce listing. In other words, the computer instruction 412 can include an instruction to use the digital content 410 as listing content within an ecommerce listing. The computer instruction 412 can be formatted according to the protocols of an application programming interface of the external computing platform 414 that creates ecommerce listings to be published.

Thus, as shown in FIG. 4, the external content generation system 106 provides the workflow output 408 (e.g., the digital content 410 and the computer instruction 412) to the external computing platform 414. In some cases, the external content generation system 106 provides the workflow output 408 to the one or more application programming interfaces 416 of the external computing platform 414. As further shown, execution of the computer instruction 412 by the external computing platform 414 provides a result (e.g., an ecommerce listing) that can be accessed by a client device 418, such as the client device that submitted the workflow request. In particular, as discussed above, the external content generation system 106 can provide the result for direct display within a graphical user interface 420 of the client device 418 or can provide a link that enables the client device 418 to access the result. In some cases, execution of the computer instruction 412 by the external computing platform 414 also provides the result to other client devices (e.g., client devices having access to the external computing platform 414).

As illustrated, the external content generation system 106 can further receive user feedback 422 with respect to the result from the client device 418. The user feedback 422 can include feedback for adjusting the workflow output 408. For instance, the user feedback 422 can indicate that detail should be added to or taken away from the digital content 410. The user feedback 422 can indicate that certain words should not be used or that other words are preferred as substitutions. The user feedback 422 can indicate other adjustments, such as an adjustment to a price listed in an ecommerce listing or a picture used in the final result. As shown in FIG. 4, the external content generation system 106 can provide the user feedback 422 to the large language model 404 and uses the large language model 404 to modify the workflow output 408 based on the user feedback 422.

In one or more embodiments, the external content generation system 106 provides the result for display by the client device 418 as a preview before the result is published on the external computing platform 414. For instance, the computer instruction 412 can include an instruction for returning a preview of the result and delaying publication of the result on the external computing platform 414 until the external content generation system 106 has confirmed that the result is ready to be published. Thus, the external content generation system 106 can ensure that the workflow output is satisfactory before it is published and accessible by other computing platforms.

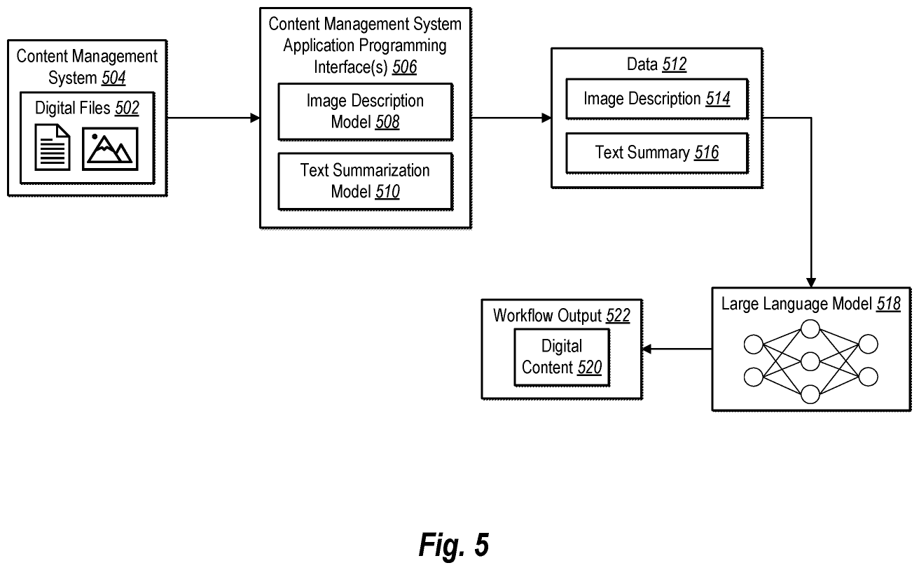

As previously indicated, the external content generation system 106 can operate more securely when compared to conventional systems. In particular, the external content generation system 106 can provide more security with regard to the digital files stored on a content management system. FIG. 5 illustrates the steps that are taken in generating digital content from digital files stored in a content management system in accordance with one or more embodiments. In particular, the diagram illustrated in FIG. 5 summarizes the processes described with respect to FIGS. 3-4 above.

As shown in FIG. 5, the external content generation system 106 accesses one or more digital files 502 stored in a content management system 504. The external content generation system 106 further uses one or more application programming interfaces 506 of the content management system 504 to process the one or more digital files 502. In some cases, as shown, the external content generation system 106 uses one or more machine learning models managed by the one or more application programming interfaces 506, such as an image description model 508 and/or a text summarization model 510. Accordingly, the external content generation system 106 determines data 512 from the one or more digital files 502, which can include an image description 514 and a text summary 516 based on the contents of the one or more digital files 502. As shown, the external content generation system 106 provides the data 512 to a large language model 518 and uses the large language model 518 to generate digital content 520 as part of the workflow output 522.

Thus, as illustrated in FIG. 5, the external content generation system 106 does not include the contents of the one or more digital files 502 directly within the digital content 520 generated as part of the workflow output 522. Further, the external content generation system 106 does not include the data 512 determined from the one or more digital files 502 within the digital content 520. Instead, the external content generation system 106 uses the large language model 518 to generate the digital content 520 from the one or more digital files 502 indirectly. Indeed, the external content generation system 106 uses the large language model 518 to generate the digital content 520 without providing the one or more digital files 502 to the large language model 518. Rather, the external content generation system 106 uses the large language model 518 to generate the digital content 520 based on distillations determined from the one or more digital files 502—such as the data segments extracted and/or derived from the contents of the one or more digital files 502 as represented within the data 512.

Accordingly, the external content generation system 106 provides one or more layers of security that prevent the one or more digital files 502 from being accessed by systems that are external to the content management system 504, such as the large language model 518 or the external computing platform that will use the workflow output 522. Indeed, as previously indicated, the large language model 518 can include a third-party large language model that is external to the content management system 504 in some implementations. Instead of providing the large language model 518 access to the contents of the one or more digital files 502 directly, the external content generation system 106 uses the one or more application programming interfaces 506 of the content management system 504 to determine the data 512 and then provides the data 512 to the large language model 518 for generating the digital content 520. Thus, neither the large language model 518 nor the external computing platform access or processes the raw data (e.g., the contents) of the one or more digital files 502—only a pre-processed version of that raw data (e.g., the data 512).

As mentioned, conventional systems often fail to securely implement workflows that integrate stored content with external systems or tools. Such systems that do implement workflows using stored content and external systems typically risk exposure of the raw data represented by the stored content to outside (potentially malicious) parties via the external systems. By operating as described above, however, the external content generation system 106 provides an approach unavailable under conventional systems that allows for the secure use of external systems, such as third-party large language models, within workflows that involve stored content.

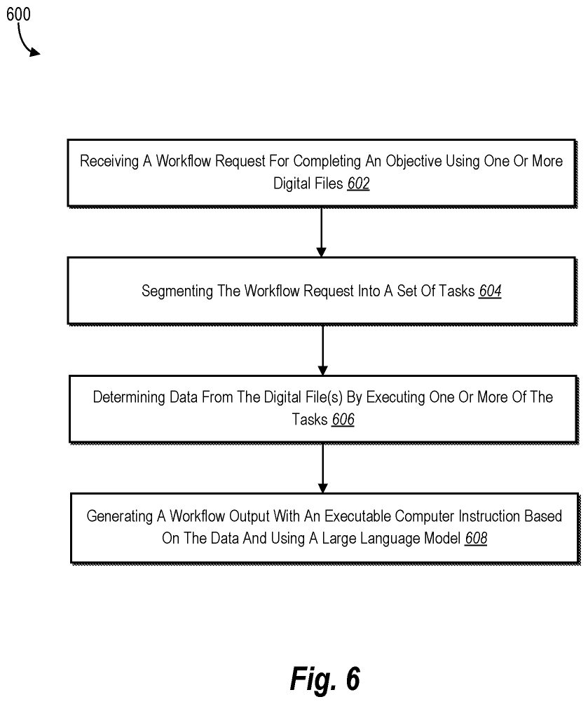

FIGS. 1-5, the corresponding text, and the examples provide a number of different methods, systems, devices, and non-transitory computer-readable media of the external content generation system 106. In addition to the foregoing, one or more embodiments can also be described in terms of flowcharts comprising acts for accomplishing the particular result, as shown in FIG. 6. FIG. 6 may be performed with more or fewer acts. Further, the acts may be performed in different orders. Additionally, the acts described herein may be repeated or performed in parallel with one another or in parallel with different instances of the same or similar acts.

FIG. 6 illustrates a flowchart of a series of acts 600 for generating a workflow output for an external computing platform based on a natural language description of an objective in accordance with one or more embodiments. FIG. 6 illustrates acts according to one embodiment, alternative embodiments may omit, add to, reorder, and/or modify any of the acts shown in FIG. 6. In some implementations, the acts of FIG. 6 are performed as part of a method. Alternatively, a non-transitory computer-readable medium can store instructions thereon that, when executed by at least one processor, cause the at least one processor to perform the acts of FIG. 6. In some embodiments, a system performs the acts of FIG. 6. For example, in one or more embodiments, a system includes at least one processor and a non-transitory computer-readable medium comprising instructions that, when executed by the at least one processor, cause the system to perform the acts of FIG. 6.

The series of acts 600 includes an act 602 for receiving a workflow request for completing an objective using one or more digital content items (e.g., one or more digital files). For example, the act 602 can involve receiving, from a client device, a workflow request comprising a natural language description of an objective to accomplish using one or more digital content items stored in a content management system.

The series of acts 600 also includes an act 604 for segmenting the workflow request into a set of tasks. For instance, the act 604 can involve segmenting the workflow request into a set of tasks for accomplishing the objective.

Additionally, the series of acts 600 includes an act 606 for determining data from the digital content item(s) (e.g., the digital file(s)) by executing one or more of the tasks. To illustrate, the act 606 can involve determining data from the one or more digital content items stored in the content management system via execution of one or more tasks from the set of tasks.

In one or more embodiments, determining the data from the one or more digital content items stored in the content management system via execution of the one or more tasks comprises at least one of extracting data segments from content of the one or more digital content items or generating derived data segments based on the content of the one or more digital content items. In some embodiments, determining the data from the one or more digital content items stored in the content management system via execution of the one or more tasks comprises generating, using an image description model, an image description for a digital image stored in the content management system. In some cases, determining the data from the one or more digital content items stored in the content management system via execution of the one or more tasks comprises generating, using a text summarization model, a text summary of a text file stored in the content management system.

Further, the series of acts 600 includes an act 608 for generating a workflow output with an executable computer instruction based on the data and using a large language model. For instance, the act 608 can involve generating, from the data determined from the one or more digital content items and using a large language model, a workflow output having a computer instruction that is executable by an external computing platform. In some embodiments, generating the workflow output from the data determined from the one or more digital content items using the large language model comprises generating the workflow output from the data determined from the one or more digital content items using a third-party large language model that is external to the content management system while preventing access to the one or more digital content items stored in the content management system by the third-party large language model.

In one or more embodiments, generating, from the data determined from the one or more digital content items and using the large language model, the workflow output having the computer instruction executable by the external computing platform comprises generating, using the large language model, digital content from the data and at least one computer instruction for using the digital content, the at least one computer instruction being executable by an application programming interface of the external computing platform.

In some cases, receiving, from the client device, the workflow request comprising the objective to accomplish using the one or more digital content items stored in the content management system comprises receiving, from the client device, the workflow request comprising the objective to post an ecommerce listing for a product or service associated with the one or more digital content items stored in the content management system. Accordingly, in some instances, generating, from the data determined from the one or more digital content items and using the large language model, the workflow output having the computer instruction that is executable by the external computing platform comprises generating, from the data and using the large language model, listing content and at least one computer instruction for creating the ecommerce listing on an ecommerce platform using the listing content. Further, in some implementations, receiving, from the client device, the workflow request comprises receiving, via a graphical user interface of the client device, user input for the workflow request, and the external content generation system 106 further provides, for display within the graphical user interface of the client device in response to receiving the user input for the workflow request, a link to the ecommerce listing on the ecommerce platform.

In one or more embodiments, the external content generation system 106 further sends the workflow output having the computer instruction to the external computing platform for execution. In some embodiments, the external content generation system 106 generates the workflow output using the large language model by generating the workflow output using a pre-trained large language model having parameters learned based on an application programming interface of the external computing platform.

To provide an illustration, in one or more embodiments, the external content generation system 106 receives, from a client device, a workflow request comprising a natural language description of an objective to accomplish using one or more machine learning models and one or more digital content items stored in a content management system; generates, from the workflow request, a plurality of tasks that, when completed, accomplish the objective of the workflow request; determines data from the one or more digital content items stored in the content management system via execution of the plurality of tasks; and generates, from the data determined from the one or more digital content items and using a large language model, a workflow output having digital content and a computer instruction for using the digital content, the computer instruction being executable by an external computing platform.

In one or more embodiments, the external content generation system 106 further provides, to the large language model, one or more prompts corresponding to the plurality of tasks for the workflow request; and generates, using the large language model, one or more instructions for completing the plurality of tasks based on the one or more prompts. In some instances, the external content generation system 106 generates, using the large language model, the one or more instructions for completing the plurality of tasks by generating at least one instruction for using a machine learning model or an application programming interface of the content management system in determining the data from the one or more digital content items.

In some embodiments, the external content generation system 106 generates the workflow output having the digital content and the computer instruction for using the digital content by generating, using the large language model, the digital content and an instruction to the external computing platform to generate viewable content that includes the digital content and is accessible by client devices via the external computing platform. In some cases, the external content generation system 106 generates the workflow output having the digital content and the computer instruction for using the digital content by generating, using the large language model, the digital content and an instruction formatted in accordance with an application programming interface of the external computing platform. In some instances, the external content generation system 106 further provides the workflow output having the digital content and the computer instruction to the external computing platform.

To provide another illustration, in one or more embodiments, the external content generation system 106 provides, for display within a graphical user interface of a client device, an interactive option for entering natural language text; receives, via the interactive option displayed in the graphical user interface, a workflow request comprising a natural language description of an objective to accomplish using one or more digital content items stored in a content management system; generates, from data determined from the one or more digital content items and using a large language model, a workflow output having digital content and a computer instruction for using the digital content, the computer instruction being executable by an external computing platform; and provides, for display within the graphical user interface of the client device in response to execution of the computer instruction by the external computing platform, viewable content that is generated by the external computing platform using the digital content or a link to the viewable content.

In one or more embodiments, the external content generation system 106 generates the workflow output having the digital content from the data determined from the one or more digital content items and using the large language model by generating the digital content of the workflow output using the large language model based on data segments extracted or derived from content of the one or more digital content items stored in the content management system without providing the one or more digital content items to the large language model. In some embodiments, the external content generation system 106 further generates, in response to receiving the workflow request, a plurality of tasks for completing the objective of the workflow request; and determines the data from the one or more digital content items stored in the content management system by executing the plurality of tasks using the large language model. In some implementations, the external content generation system 106 determines the data from the one or more digital content items stored in the content management system using one or more machine learning models of the content management system.

Each of the components of the external content generation system 106 can include software, hardware, or both. For example, the components can include one or more instructions stored on a computer-readable storage medium and executable by processors of one or more computing devices, such as a client device or server device. When executed by the one or more processors, the computer-executable instructions of the external content generation system 106 can cause the computing device(s) to perform the methods described herein. Alternatively, the components can include hardware, such as a special-purpose processing device to perform a certain function or group of functions. Alternatively, the components of the external content generation system 106 can include a combination of computer-executable instructions and hardware.

Furthermore, the components of the external content generation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the external content generation system 106 may be implemented as a stand-alone application, such as a desktop or mobile application. Furthermore, the components of the external content generation system 106 may be implemented as one or more web-based applications hosted on a remote server. Alternatively, or additionally, the components of the external content generation system 106 may be implemented in a suite of mobile device applications or “apps.”

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of an example computing device 700 that may be configured to perform one or more of the processes described above. One will appreciate that one or more computing devices, such as the computing device 700 may represent the computing devices described above (e.g., the server device(s) 102, the client device 110, the third-party system 118, and/or the external computing platform 120). In one or more embodiments, the computing device 700 may be a mobile device (e.g., a mobile telephone, a smartphone, a PDA, a tablet, a laptop, a camera, a tracker, a watch, a wearable device). In some embodiments, the computing device 700 may be a non-mobile device (e.g., a desktop computer or another type of client device). Further, the computing device 700 may be a server device that includes cloud-based processing and storage capabilities.

As shown in FIG. 7, the computing device 700 can include one or more processor(s) 702, memory 704, a storage device 706, input/output interfaces 708 (or “I/O interfaces 708”), and a communication interface 710, which may be communicatively coupled by way of a communication infrastructure (e.g., bus 712). While the computing device 700 is shown in FIG. 7, the components illustrated in FIG. 7 are not intended to be limiting. Additional or alternative components may be used in other embodiments. Furthermore, in certain embodiments, the computing device 700 includes fewer components than those shown in FIG. 7. Components of the computing device 700 shown in FIG. 7 will now be described in additional detail.

In particular embodiments, the processor(s) 702 includes hardware for executing instructions, such as those making up a computer program. As an example, and not by way of limitation, to execute instructions, the processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 704 may be internal or distributed memory.

The computing device 700 includes a storage device 706 including storage for storing data or instructions. As an example, and not by way of limitation, the storage device 706 can include a non-transitory storage medium described above. The storage device 706 may include a hard disk drive (HDD), flash memory, a Universal Serial Bus (USB) drive or a combination these or other storage devices.

As shown, the computing device 700 includes one or more I/O interfaces 708, which are provided to allow a user to provide input to (such as user strokes), receive output from, and otherwise transfer data to and from the computing device 700. These I/O interfaces 708 may include a mouse, keypad or a keyboard, a touch screen, camera, optical scanner, network interface, modem, other known I/O devices or a combination of such I/O interfaces 708. The touch screen may be activated with a stylus or a finger.

The I/O interfaces 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 708 are configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 provides one or more interfaces for communication (such as, for example, packet-based communication) between the computing device and one or more other computing devices or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can include hardware, software, or both that connects components of computing device 700 to each other.

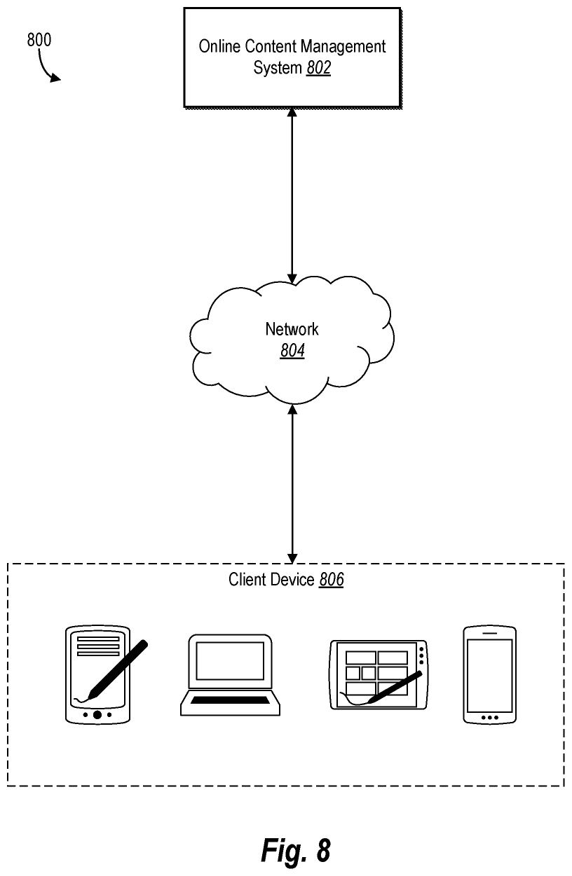

FIG. 8 is a schematic diagram illustrating a network environment 800 within which one or more implementations of the external content generation system 106 can be implemented. For example, the external content generation system 106 may be part of a content management system 802 (e.g., the content management system 104). The content management system 802 may generate, store, manage, receive, and send digital content (such as digital content items). For example, the content management system 802 may send and receive digital content to and from client device(s) 806 by way of a network 804. In particular, the content management system 802 can store and manage a collection of digital content. The content management system 802 can manage the sharing of digital content between computing devices associated with a plurality of users. For instance, the content management system 802 can facilitate a user sharing digital content with another user of the content management system 802.

In particular, the content management system 802 can manage synchronizing digital content across multiple client devices 806 associated with one or more users. For example, a user may edit digital content using client device 806. The content management system 802 can cause client device 806 to send the edited digital content to the content management system 802. The content management system 802 then synchronizes the edited digital content on one or more additional computing devices.

In addition to synchronizing digital content across multiple devices, one or more implementations of the content management system 802 can provide an efficient storage option for users that have large collections of digital content. For example, the content management system 802 can store a collection of digital content on the content management system 802, while the client device 806 only stores reduced-sized versions of the digital content. A user can navigate and browse the reduced-sized versions (e.g., a thumbnail of a digital image) of the digital content on the client device 806. In particular, one way in which a user can experience digital content is to browse the reduced-sized versions of the digital content on the client device 806.

Another way in which a user can experience digital content is to select a reduced-size version of digital content to request the full- or high-resolution version of digital content from the content management system 802. In particular, upon a user selecting a reduced-sized version of digital content, the client device 806 sends a request to the content management system 802 requesting the digital content associated with the reduced-sized version of the digital content. The content management system 802 can respond to the request by sending the digital content to the client device 806. The client device 806, upon receiving the digital content, can then present the digital content to the user. In this way, a user can have access to large collections of digital content while minimizing the amount of resources used on the client device 806.

The client device 806 may be a desktop computer, a laptop computer, a tablet computer, a personal digital assistant (PDA), an in- or out-of-car navigation system, a smart TV, a virtual reality (VR) or augmented reality (AR) device, a handheld device, a wearable device, a smartphone or other cellular or mobile phone, or a mobile gaming device, other mobile device, or other suitable computing devices. The client device 806 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.) to access and view content over the network 804.

The network 804 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the client device(s) 806 may access the content management system 802.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a client device, a workflow request comprising a natural language description of an objective to accomplish using one or more digital content items stored in a content management system;
segmenting the workflow request into a set of tasks for accomplishing the objective;
determining data from the one or more digital content items stored in the content management system via execution of one or more tasks from the set of tasks; and
generating, from the data determined from the one or more digital content items and using a large language model, a workflow output having a computer instruction that is executable by an external computing platform.

2. The method of claim 1, wherein generating, from the data determined from the one or more digital content items and using the large language model, the workflow output having the computer instruction executable by the external computing platform comprises generating, using the large language model, digital content from the data and at least one computer instruction for using the digital content, the at least one computer instruction being executable by an application programming interface of the external computing platform.

3. The method of claim 1, wherein:
receiving, from the client device, the workflow request comprising the objective to accomplish using the one or more digital content items stored in the content management system comprises receiving, from the client device, the workflow request comprising the objective to post an ecommerce listing for a product or service associated with the one or more digital content items stored in the content management system; and
generating, from the data determined from the one or more digital content items and using the large language model, the workflow output having the computer instruction that is executable by the external computing platform comprises generating, from the data and using the large language model, listing content and at least one computer instruction for creating the ecommerce listing on an ecommerce platform using the listing content.

4. The method of claim 3,
wherein receiving, from the client device, the workflow request comprises receiving, via a graphical user interface of the client device, user input for the workflow request; and
further comprising providing, for display within the graphical user interface of the client device in response to receiving the user input for the workflow request, a link to the ecommerce listing on the ecommerce platform.

5. The method of claim 1, wherein generating the workflow output from the data determined from the one or more digital content items using the large language model comprises generating the workflow output from the data determined from the one or more digital content items using a third-party large language model that is external to the content management system while preventing access to the one or more digital content items stored in the content management system by the third-party large language model.

6. The method of claim 1, further comprising sending the workflow output having the computer instruction to the external computing platform for execution.

7. The method of claim 1, wherein determining the data from the one or more digital content items stored in the content management system via execution of the one or more tasks comprises at least one of extracting data segments from content of the one or more digital content items or generating derived data segments based on the content of the one or more digital content items.

8. The method of claim 1, wherein determining the data from the one or more digital content items stored in the content management system via execution of the one or more tasks comprises generating, using an image description model, an image description for a digital image stored in the content management system.

9. The method of claim 1, wherein determining the data from the one or more digital content items stored in the content management system via execution of the one or more tasks comprises generating, using a text summarization model, a text summary of a text file stored in the content management system.

10. The method of claim 1, wherein generating the workflow output using the large language model comprises generating the workflow output using a pre-trained large language model having parameters learned based on an application programming interface of the external computing platform.

11. A system comprising:
at least one processor; and
a non-transitory computer-readable medium comprising instructions that, when executed by the at least one processor, cause the system to:
receive, from a client device, a workflow request comprising a natural language description of an objective to accomplish using one or more machine learning models and one or more digital content items stored in a content management system;
generate, from the workflow request, a plurality of tasks that, when completed, accomplish the objective of the workflow request;
determine data from the one or more digital content items stored in the content management system via execution of the plurality of tasks; and
generate, from the data determined from the one or more digital content items and using a large language model, a workflow output having digital content and a computer instruction for using the digital content, the computer instruction being executable by an external computing platform.

12. The system of claim 11, further comprising instructions that, when executed by the at least one processor, cause the system to:
provide, to the large language model, one or more prompts corresponding to the plurality of tasks for the workflow request; and
generate, using the large language model, one or more instructions for completing the plurality of tasks based on the one or more prompts.

13. The system of claim 12, further comprising instructions that, when executed by the at least one processor, cause the system to generate, using the large language model, the one or more instructions for completing the plurality of tasks by generating at least one instruction for using a machine learning model or an application programming interface of the content management system in determining the data from the one or more digital content items.

14. The system of claim 11, further comprising instructions that, when executed by the at least one processor, cause the system to generate the workflow output having the digital content and the computer instruction for using the digital content by generating, using the large language model, the digital content and an instruction to the external computing platform to generate viewable content that includes the digital content and is accessible by client devices via the external computing platform.

15. The system of claim 11, further comprising instructions that, when executed by the at least one processor, cause the system to generate the workflow output having the digital content and the computer instruction for using the digital content by generating, using the large language model, the digital content and an instruction formatted in accordance with an application programming interface of the external computing platform.

16. The system of claim 11, further comprising instructions that, when executed by the at least one processor, cause the system to provide the workflow output having the digital content and the computer instruction to the external computing platform.

17. A non-transitory computer-readable medium comprising instructions that, when executed by at least one processor, cause the at least one processor to:
provide, for display within a graphical user interface of a client device, an interactive option for entering natural language text;
receive, via the interactive option displayed in the graphical user interface, a workflow request comprising a natural language description of an objective to accomplish using one or more digital content items stored in a content management system;
generate, from data determined from the one or more digital content items and using a large language model, a workflow output having digital content and a computer instruction for using the digital content, the computer instruction being executable by an external computing platform; and
provide, for display within the graphical user interface of the client device in response to execution of the computer instruction by the external computing platform, viewable content that is generated by the external computing platform using the digital content or a link to the viewable content.

18. The non-transitory computer-readable medium of claim 17, further comprising instructions that, when executed by the at least one processor, cause the at least one processor to generate the workflow output having the digital content from the data determined from the one or more digital content items and using the large language model by generating the digital content of the workflow output using the large language model based on data segments extracted or derived from content of the one or more digital content items stored in the content management system without providing the one or more digital content items to the large language model.

19. The non-transitory computer-readable medium of claim 17, further comprising instructions that, when executed by the at least one processor, cause the at least one processor to:
generate, in response to receiving the workflow request, a plurality of tasks for completing the objective of the workflow request; and
determine the data from the one or more digital content items stored in the content management system by executing the plurality of tasks using the large language model.

20. The non-transitory computer-readable medium of claim 19, further comprising instructions that, when executed by the at least one processor, cause the at least one processor to determine the data from the one or more digital content items stored in the content management system using one or more machine learning models of the content management system.
